(19) United States
(12) Patent Application Publication
(10) Pub. No.: US 2008/0137863 A1
(43) Pub. Date: Jun. 12, 2008

(54) METHOD AND SYSTEM FOR USING A KEY MANAGEMENT FACILITY TO NEGOTIATE A SECURITY ASSOCIATION VIA AN INTERNET KEY EXCHANGE ON BEHALF OF ANOTHER DEVICE

(75) Inventor: PETER E. THOMAS, SCHAUMBURG, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/567,489

(22) Filed: Dec. 6, 2006

(51) Int. Cl. H04L 9/16; H04L 9/14

(52) U.S. Cl. 380/273; 380/277

(57) ABSTRACT

A key management facility for a communication network masquerades as a first device within the communication system during an Internet Key Exchange (IKE) negotiation with a second device within the communication system. The key management facility establishes, on behalf of the first device, a security association with the second device using IKE. After the negotiation is complete, the key management device provides information regarding the security association to the first device such that the first device can engage in an Internet Protocol Security-protected communication with the second device.

### TECHNICAL FIELD OF THE DISCLOSURE

This disclosure relates generally to communications, and more particularly to security association negotiated via an Internet Key Exchange.

### BACKGROUND OF THE DISCLOSURE

Communication systems and networks of various kinds are known in the art. Many such systems comprise, at least in part, a wireless network. In many cases, these wireless networks support secure communications via a key management facility. Such a key management facility typically serves, for example, to handle over-the-air-rekeying (OTAR) and key variable loading services to ensure that various platforms communicating securely via the wireless network are using current and appropriate encryption parameters and protocols pertaining to that particular wireless network.

The Internet key exchange (IKE) is also known in the art (see, for example, Internet Engineering Task Force RFC 2409). The IKE is a negotiation protocol that serves to establish at least one security association parameter. This functionality comprises a mandatory part of Internet Protocol version 6 and an optional part of Internet Protocol version 4. IKE comprises a part of the Internet Protocol Security protocol suite (IPSec) which generally comprises a standard for secure Internet Protocol communications via encryption and/or authentication of Internet Protocol packets. IPSec in general comprises a set of cryptographic protocols for securing packet flows and for facilitating key exchanges.

There are times when is it desired to provide end-to-end security via IPSec when communicating with wireless mobile stations. In some cases, the mobile station may be able to perform the necessary IKE negotiations to facilitate setting up an IPSec security association between itself and another IPSec-enabled device. There are other times and scenarios, however, when such is not the case. A given mobile station may lack sufficient bandwidth or processing power to ensure adequate completion of these tasks. In other cases, the mobile station may be technically capable of effecting such negotiations but the corresponding power consumption and/or computational diversion may be unacceptable.

### BRIEF DESCRIPTION OF THE FIGURES

The above needs are at least partially met through provision of the key management facility used to negotiate a security association via the IKE on behalf of a mobile station described in the following detailed description, particularly when studied in conjunction with the drawings, wherein:

FIG. 1 illustrates a block diagram of an exemplary topology of a communication system in accordance with the present disclosure;

FIG. 2 illustrates a bounce diagram when the IPSec device initiates communication with the mobile station in accordance with the present disclosure; and

FIG. 3 illustrates a bounce diagram when the mobile station initiates communication with the IPSec device in accordance with the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE DISCLOSURE

Generally speaking, pursuant to these various embodiments, a key management facility (KMF) for a communication system masquerades as a first device within the communication system during an IKE negotiation with a second device within the communication system. The KMF establishes, on behalf of a first device, a security association with the second device using IKE. The KMF provides information regarding the established security association to the first device such that the first device can engage in an IPSec-protected communication with the second device.

By one approach the first device instigates such actions by transmitting a request to the KMF to establish the security association. By another approach the request can be received from the second device via an IKE proxy. These teachings are applicable to facilitate establishing an initial security association. These teachings are also applicable to facilitate and handle the re-negotiation of the security association should such be advisable, useful, or necessary.

So configured, an IKE-negotiated security association is readily established (and/or re-established) as needed to permit an end-to-end IPSec-protected communication session between the first device and the second device without requiring that the first device itself employ, or be a part of, the IKE negotiation to establish that security association with the second device. This, in turn, offloads considerable computational complexities and resource requirements from the first device without requiring compromises beyond those ordinarily encountered in a centralized key management system. These and other benefits may become clearer upon making a thorough review and study of the following detailed description with reference to the figures. For purposes of clarity only, and is not intended to be limiting in any manner, the following description refers to the first device as a mobile station (since in many cases it is desirable to offload computational complexities and resource requirements in mobile stations due to power and processing constraints) and refers to the second device as an IPSec-enabled device. It should be noted that the first device and the second device can be fixed, portable or mobile.

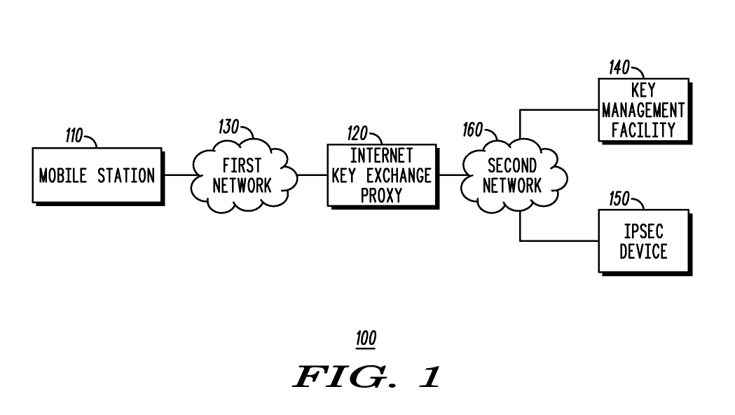

FIG. 1 illustrates an exemplary topology of a communication system 100 in accordance with the present disclosure. As illustrated, a mobile station 110 is coupled to an IKE proxy 120 via a first network 130. The IKE proxy 120 is also coupled to a KMF 140 and an IPSec-enabled device 150 via a second network 160. A person of ordinary skill in the art will realize that the communication system 100 can be configured in a variety of topologies, all of which fall within the spirit and scope of the present disclosure, such that all traffic in the communication system 100 does not necessarily have to traverse the IKE proxy 120 (e.g., communications between the mobile station 110 and the KMF 140 do not have to traverse the IKE proxy 120). It is important to note, however, that all IKE traffic from the IPSec-enabled device 150 to the mobile station 110 must traverse the IKE proxy 120, but non-IKE traffic (e.g., encapsulating security payload (ESP) or authentication header (AH) protected traffic) between the mobile station 110 and the IPSec-enabled device 150 can use some other route which does not traverse the IKE proxy 120. Alternatively, depending on whether egress filtering or a similar technique is employed in the communication system 100, any IKE traffic that appears to be from the mobile station 110 (e.g., sent from the subnet of the KMF 140 masquerading as the mobile station 110) to the IPSec-enabled device 150 may not need to traverse the IKE proxy 120.

The mobile station 110 is any communication device that is capable of communicating with an IPSec-enabled device 150 using security association negotiated on its behalf via IKE, and capable of communicating with a KMF 140 to obtain and/or request the parameters needed to form an IKE negotiated security association. The mobile station 110 may access the first network 130 using either a wired or wireless interface. In accordance with the present disclosure, the mobile station receives a message from the KMF 140 comprising IKE-negotiated security association information. The message from the KMF 140 can be received, if desired, using a form of transmission security other than a security association that uses IKE. This can comprise using, for example, OTAR techniques that are commonly known in the art. Upon receipt, the mobile station 110 uses the IKE-negotiated security association information to facilitate an IPSec-protected communication with another device in the communication system 100 other than the KMF 140 (e.g., with the IPSec-enabled device 150). Such usage of the IKE-negotiated security association information is a well-understood area of practice and endeavor and hence requires no further description or elaboration here. Receipt of the IKE-negotiated security association information can be in response to an IPSec-enabled device 150 initiating a request for an IPSec-protected communication with the mobile station 110 or can be in response to the mobile station itself 110 initiating a request via the IKE proxy 120 and the KMF 140 for the IPSec-protected communication with the IPSec-enabled device 150.

Those skilled in the art will understand and appreciate that the mobile station 110, now equipped with a freshly negotiated security association, can engage in an IPSec-protected communication without itself having had to participate in the necessary prerequisite negotiations that define IP Sec standards in this regard. The mobile station 110 has thus been spared the computation and power requirements and obligations that would otherwise attend such a result.

These teachings are readily applied, as described, to facilitate initial IPSec-based negotiations. These teachings also encompass, however, subsequent IKE re-negotiations. Such re-negotiations are known in the art and can be prompted by any of a wide variety of triggering circumstances. To support such a need, for example, the mobile station 110 can support directing a request to renegotiate the IKE-negotiated security association to the KMF 140. The KMF 140 can then conduct an IKE renegotiation on behalf of the mobile station 110. When the mobile station 110 then receives the resultant renegotiated information from the KMF 140, the mobile station 110 uses the renegotiated IKE-negotiated security association information to facilitate IPSec-protected communications with the IPSec-enabled device 150.

The IKE proxy 120 may be a discrete device within the communication system 100, may be an integral part of the KMF itself, or may be embedded in another device within the communication system 100, such as a router, depending upon the needs and/or limitations of a given application setting. One of the advantages of embedding the IKE proxy 120 in a router ensures that the traffic between the mobile station 110 and the IPSec-enabled device 150 traverses the IKE proxy 120. It should also be noted that while the IKE proxy 120 and the KMF 140 are depicted as separate devices, their functionality may be combined into a single device or shared amongst a plurality of devices. For ease of explanation and clarity, the present disclosure assumes that the IKE proxy 120 and the KMF 140 are discrete devices. Again, it is important to note that all IKE traffic to the mobile station 110 and from the IPSec-enabled device 150 must traverse the IKE proxy 120; however, all other traffic can use some other route which does not traverse the IKE proxy 120.

In accordance with the present disclosure, the KMF 140 can establish, on behalf of a mobile station 110 that is within the communication system 100 and that is served by the KMF 140, a security association using IKE if properly configured to masquerade as the mobile station 110 during IKE negotiations with the IPSec-enabled device 150. In other words, the KMF 140 makes the IPSec-enabled device 150 believe that it is the mobile station 110 by responding to the IPSec-enabled device 150 as if it were the mobile station 110 during IKE negotiations. In one embodiment, the KMF 140 comprises a processor that operably couples to an Internet Protocol-compatible interface. This interface provides a means whereby the KMF 140 communicates with IPSec-enabled devices 150. Accordingly, this interface is also operably coupled to the IKE proxy 120. As noted above, the IKE proxy 120 may be an integral part of the KMF 140 or the IKE proxy 120 and the KMF 140 may be discrete components. Regardless of the configuration, those skilled in the art will recognize that the IKE proxy 120 is able to exchange IKE messages between the processor of the KMF 140 and the IPSec-enabled devices 150. So configured, the processor is configured and arranged (via, for example, corresponding programming) to effect some or all of the steps and functionality described herein. This can include, for example, establishing, on behalf of a mobile station 110, a security association using IKE and then providing information regarding that security association to the mobile station 110 such that the mobile station 110 can engage in an IPSec-protected communication.

This KMF 140 also comprises a communications network interface. By one approach the Internet Protocol-compatible interface also serves as the communications network interface. The latter approach, for example, can serve well when the KMF 140 is coupled to the wireless network via an Internet Protocol-based network. When such is not the case, a discrete communications network interface can be provided to compatibly support and utilize the appropriate protocol of choice.

As noted above, if desired, such a KMF 140 can be pre-provisioned with authentication information (e.g., both an asymmetric public key and asymmetric private key, shared symmetric key, both a username and password or the like) for one or more mobile stations 110. To support such an approach, the KMF 140 can further optionally comprise a memory 206 that operably couples to the processor. The memory can store the authentication information for one or more mobile stations 110, and in turn, the KMF 140 can use the authentication information as may be available in the memory when establishing the security association. This memory can also store security parameters for use with the non-IKE protocol (such as the keying material and algorithms used to protect the OTAR protocol of choice). Alternatively, authentication information can be provided, if desired, to the KMF 140 via the mobile station 110 at the time of establishing 103 this security association.

Those skilled in the art will recognize and understand that such a KMF 140 may be comprised of a plurality of physically distinct elements as described above. It is also possible, however, that one or more of these elements can be enabled and realized via a shared platform. It will also be understood that such a shared platform may comprise a wholly or at least partially programmable platform as are known in the art.

This step of establishing a security association on behalf of a mobile station 110 can itself comprise a response to, for example, receipt of a message comprising a request to establish a security association using IKE. Such a message can be sourced, for example, by the mobile station itself 110. Such a message can also be ultimately sourced by an IPSec-enabled device 150. In the case of the latter, these teachings accommodates the KMF 140 receiving this message via an IKE proxy 120 that forwards this message when received from such an IPSec-enabled device 150. As will be shown below, this IKE proxy 120 can comprise a part of the KMF 140 or can be external thereto depending upon the needs and/or limitations of a given application setting.

Upon establishing the security association, the KMF 140 facilitates providing information regarding that security association to the mobile station 110. This can comprise, for example, providing the information using a form of secure transmission other than a security association that uses IKE. As but one illustrative example in this regard, the KMF 140 can employ its own OTAR process to impart this security association information to the mobile station 110.

The information imparted can comprise, for example, the IPSec security association parameters themselves. For example, the KMF 140 can provide the mobile station 110 with the specific keys that are to be used with the security association. By another approach, however, this information may comprise some of the security association parameters but not necessarily the IPSec key or keys themselves. Instead, if desired, the transmitted information could comprise an IKE-negotiated shared secret. This, in turn, could be employed by the mobile station 110 to generate the IPSec key(s). Such an approach might offer benefits, for example, with respect to subsequently developing new keys based upon the original IKE negotiation.

The IPSec-enabled device 150 can be any communication device that is capable of communicating with another IPSec-enabled device using a security association negotiated via IKE. The IPSec-enabled device 150 could be a laptop computer, desktop computer, personal digital assistant (PDA), cellular telephone, or any other device that is capable of communicating via an IKE negotiated IPSec security association. In accordance with the present disclosure, the IPSec-enabled device 150 also communicates with the mobile station 110 since the IPSec-enabled device 150 believes that the mobile station 110 is also an IPSec-enabled device because the KMF 140 masquerades as the mobile station 110 during IKE negotiations with the IPSec-enabled device 150. The IPSec-enabled device 150 may access the second network 160 using either a wired or wireless interface.

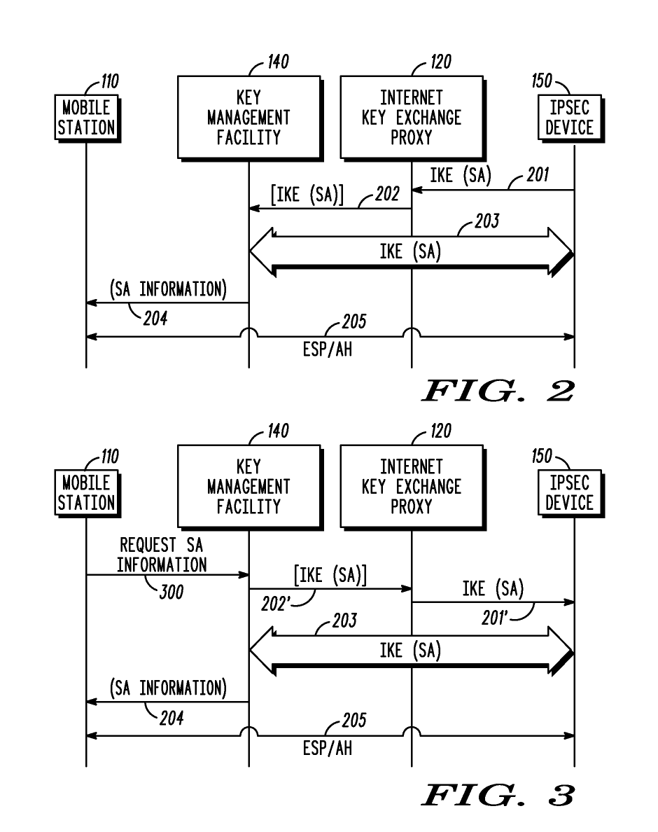

Let us now refer to FIGS. 2 and 3 to illustrate two examples of the message flow in the communication system 100 between the mobile station 110, the IKE proxy 120, the KMF 140, and the IPSec-enabled device 150. It is important to remember that all traffic in the communication system 100 does not necessarily have to traverse the IKE proxy 120, however, all IKE traffic to the mobile station 110 and from the IPSec-enabled device 150 must traverse the IKE proxy 120.

As illustrated in FIG. 2, the IPSec-enabled device 150 desires to initiate communication with the mobile station 110. The IPSec-enabled device 150 transmits an IKE message to the mobile station 110. The IKE message is intercepted by the IKE proxy 120, which then starts negotiations of a security association (step 201). The IKE message travels the normal IP routing path towards the mobile station 110 to reach the IKE proxy 120. Upon receipt of the message from the IPSec-enabled device 150, the IKE proxy 120 recognizes that the message is an IKE message by identifying the IKE port in the User Datagram Protocol (UDP) header of the IKE message which is well known in the art and will not be discussed in further detail. As a result, the IKE proxy 120 encapsulates the IKE message to form an encapsulated message (at step 202) and forwards the encapsulated message to the KMF 140 (at step 202).

Upon receipt, the KMF 140 decapsulates the encapsulated message and determines the destination address for the IKE message. The KMF 140 associates the destination address with a destination device, which in this example is mobile station 110. There are various ways in which the KMF 140 can perform the association that are commonly known in the art, such as, for example, using a look-up table. The selected association method also provides the KMF 140 with access to authentication information that is necessary to authenticate the IKE negotiation of the security association with the IPSec-enabled device 150. For example, assuming that a look-up table is the association method that is utilized, the table entry would also include an asymmetric public key and an asymmetric private key for the mobile station 110. Note that the asymmetric public key could be stored as part of a digital certificate digitally signed by a party trusted by the KMF 140 (e.g., a certificate authority). The KMF 140 retrieves and uses the authentication information to complete the IKE negotiation of the security association with the IPSec-enabled device 150 via the IKE proxy 120 (at step 203). Alternatively, the KMF 140 may request the authentication information from the mobile station 110. Once the IKE negotiation is completed resulting in an established security association, the IPSec-enabled device 150 stores the security association for later use when communicating non-IKE communications directly with the mobile station 110. The KMF 140 communicates the established security association to the mobile station 110 (step 204).

Upon receipt, the mobile station 110 stores the security association. Once both the mobile station 110 and the IPSec-enabled device 150 stored the security association, the mobile station 110 and the IPSec-enabled device 150 can communicate non-IKE traffic with each other directly via an encryption protocol (such as the encapsulating security payload or ESP), an authentication protocol (such as authentication header or AH), a combination of protocols, or the like (at step 205).

Let us now refer to FIG. 3 and describe when the mobile station 110 desires to initiate communication with the IPSec-enabled device 150. The flow of messages is very similar to that when the IPSec-enabled device 150 is initiating communication with the mobile station 110. In this example, the mobile station 110 sends a request to the KMF 140 to negotiate a security association with the IPSec-enabled device 150 via the IKE (at step 300). Upon receipt of the request, the KMF 140 associates the mobile station's address from the header or payload of the request (from step 300) with a source device, which in this example is mobile station 110, and retrieves the corresponding authentication information (e.g., an asymmetric public key and asymmetric private key for the mobile station 110) that is necessary to authenticate the IKE negotiation of the security association with the IPSec-enabled device 150. The KMF 140 performs this association and retrieval of authentication information as described above with reference to FIG. 2. Alternatively, the KMF 140 may request the authentication information from the mobile station 110 or the mobile station 110 may provide the authentication information to the KMF 140, for example as part of message 300.

The KMF 140 may or may not verify that the mobile station 110 is authorized to request from the KMF a security association via the IKE. If the KMF 140 performs the verification and determines that the mobile station 110 is not authorized to request a security association via the IKE, the KMF 140 denies the request. If, on the other hand, the KMF 140 performs the verification and determines that the mobile station 110 is authorized to request a security association via the IKE, or if the verification is not required, in one embodiment, the KMF 140 forms an IKE message authenticated with the retrieved authentication information for the mobile station 110, encapsulates the IKE message, and forwards the encapsulated IKE message to the IKE proxy 120 (at step 202′; this step is 202′ because the encapsulated message is substantially similar to the encapsulated message sent in step 202 except it is sent from the KMF 140 to the IKE proxy 120). Alternatively, in another embodiment, if the KMF 140 performs the verification and determines that the mobile station 110 is authorized to request a security association via the IKE, or if the verification is not required, the KMF 140 forms the IKE message authenticated with the retrieved authentication information for the mobile station 110 and forwards the IKE message directly to the IPSec-enabled device 150. This alternative embodiment is only applicable if the communication system 100 does not apply egress filtering rules that require that a router or similar device ensures that the source address of all packets forwarded to other devices is valid before forwarding the packets. In other words, if the IKE negotiation appears to be between the IPSec-enabled device 150 and the mobile station 110, but the IKE negotiation is actually between the IPSec-enabled device 150 and the KMF 140 masquerading as the mobile station 110 as described in the present disclosure, some routers or firewalls will discard the packets without forwarding the packets to the appropriate device.

Upon receipt, the IKE proxy 120 decapsulates the IKE message and recognizes that the encapsulated message comprises an IKE message and forwards the IKE message to the IPSec device (at step 201′; again, this step is 201′ because the IKE message is substantially similar to the IKE message sent in step 201 except it is sent from the IKE proxy 140 to the IPSec-enabled device 150). At this point, the message flow between FIGS. 2 and 3 are substantially the same. The KMF 140 retrieves and uses the authentication information to complete the IKE negotiation of the security association with the IPSec-enabled device 150 via the IKE proxy 120 (at step 203). Once the IKE negotiation is completed resulting in an established security association, the IPSec-enabled device 150 stores the security association for later use when communicating non-IKE communications directly with the mobile station 110. The KMF 140 communicates the established security association to the mobile station 110 (step 204).

Upon receipt, the mobile station 110 stores the security association. Once both the mobile station 110 and the IPSec-enabled device 150 stored the security association, the mobile station 110 and the IPSec-enabled device 150 can communicate non-IKE communications with each other directly via an encryption protocol (such as ESP), an authentication protocol (such as AH), a combination of protocols, or the like (at step 205).

It should be noted that in some embodiments, the communications between the mobile station 110 and the KMF 140 may be made via a secure conveyance mechanism, such as the OTAR protocol, however, other protocols may be used. Such a mechanism ensures that the information transmitted between the mobile station 110 and the KMF 140 is secure (such as the security parameters). In other embodiments, however, the communications between the mobile station 110 and the KMF 140 may be unprotected.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Those skilled in the art will appreciate that these teachings are readily implemented and deployable without significant cost or burden. Once implemented, these teachings then offer the potential for avoiding computational processing requirements and/or corresponding power consumption needs for the mobile station 110. This, in turn, can potentially expand opportunities for the communication system 100 to interact with a wider base of end user platforms and applications.

Those skilled in the art will recognize that a wide variety of modifications, alterations, and combinations can be made with respect to the above described embodiments without departing from the spirit and scope of the disclosure, and that such modifications, alterations, and combinations are to be viewed as being within the ambit of the inventive concept. For example, these teachings are also applicable in settings when it would be beneficial to have the mobile station 110 itself comprise a wired device that is managed by a KMF 140 (when, for example, an application setting is characterized by power and/or computational constraints but not bandwidth constraints). In this example, the mobile station 110 need not be mobile in the traditional sense (e.g., fixed).

I claim:

1. A method comprising:
at a key management facility for a communications system:
masquerading as a first device within the communication system during a first Internet Key Exchange (IKE) negotiation with a second device within the communication system;
establishing, on behalf of the first device, a security association with the second device using IKE; and
providing information regarding the security association to the first device such that the first device can engage in an Internet Protocol Security-protected communication with the second device.

2. The method of claim 1 further comprising receiving a message comprising a request to establish a security association using IKE.

3. The method of claim 2 wherein the request to establish a security association using IKE is received from the second device via an IKE proxy.

4. The method of claim 2 wherein the request to establish a security association using IKE is received from the first device.

5. The method of claim 1 wherein during the first IKE negotiation, messages from the second device to the key management facility traverse an IKE proxy.

6. The method of claim 5 wherein the IKE proxy is integral to the key management facility.

7. The method of claim 1 further comprising:
receiving a request to renegotiate the security association on behalf of the first device with the second device;
masquerading as the first device during a second IKE negotiation with the second device; and
establishing a new security association with the second device on behalf of the first device using IKE,
wherein the second IKE negotiation uses at least a subset of information negotiated from the first IKE negotiation.

8. The method of claim 1 wherein the first IKE negotiation is authenticated using authentication information corresponding to the first device.

9. The method of claim 8 wherein the authentication information comprises at least one of a shared symmetric key, an asymmetric public key, an asymmetric private key a username, and a password.

10. The method of claim 8 wherein the key management facility is pre-provisioned with the authentication information.

11. The method of claim 8 further comprising obtaining the authentication information from the first device.

12. The method of claim 1 wherein providing information regarding the security association to the first device comprises providing the information using an over-the-air-rekeying protocol.

13. A key management facility comprising:
at least one interface configured and arranged to permit communications with a first device and a second device;
a processor operably coupled to the at least one interface configured and arranged to:
masquerade as the first device within the communication system during a first Internet Key Exchange (IKE) negotiation with the second device within the communication system;
establish, on behalf of the first device, a security association with the second device using IKE; and
provide information regarding the security association to the first device such that the first device can engage in an Internet Protocol Security-protected communication with the second device.

14. The key management facility of claim 13 wherein the at least one interface operably couples to an IKE proxy.

15. The key management facility of claim 13 wherein the IKE proxy comprises a part of the key management facility.

16. The key management facility of claim 13 further comprising a memory operably coupled to the processor and pre-provisioned with authentication information corresponding to the first device stored therein, and wherein the processor is further configured and arranged to use the authentication information when establishing the security association using IKE.

17. A communication system comprising:
a first device coupled to a first network;
an Internet Key Exchange (IKE) proxy coupled to the first device via the first network;
a key management facility coupled to the first device and the IKE proxy; and
a second device coupled to the IKE proxy,
wherein the key management facility masquerades as the first device during an during an IKE negotiation with the second device, establishes, on behalf of the first device, a security association with the second device using IKE, and provides information regarding the security association to the first device such that the first device can engage in an Internet Protocol Security-protected communication with the second device.

18. The communication system of claim 17 wherein, during the IKE negotiation, messages from the second device to the key management facility traverse the IKE proxy.

19. The communication system of claim 17 wherein the IKE negotiation is authenticated using authentication information corresponding to the first device.

20. The communication system of claim 17 wherein the key management facility comprises the IKE proxy.
